(19) United States
(12) Patent Application Publication
(10) Pub. No.: US 2005/0262717 A1
(43) Pub. Date: Dec. 1, 2005

(54) Structure tape rule housing

(76) Inventor: Michael Chen, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/852,186

(22) Filed: May 25, 2004

(51) Int. Cl. G01B 3/10

(52) U.S. Cl. 33/761

(57) ABSTRACT

An improved structure tape rule housing in which the tape rule housing consists of pliant rubber material, exterior layer ruler blade housing jackets of a color different from that of the interior layer ruler blade housings which cover the upper edge or lower edge at both the left and right side of the interior layer ruler blade housings to increase grasping friction and utilization comfort. At the same time, the interior layer ruler blade housing has reliefed labeling and markings, and by design the exterior layer ruler blade housing jackets each have a reticulation aligned with the positions of the labeling and markings. The exterior layer ruler blade housing jackets are fitted over the interior layer ruler blade housings, enabling the visual exposure of the interior layer ruler blade housing labeling and markings through the exterior layer ruler blade housing jackets, thereby increasing the practical value of the tape rule housing structure.

### BACKGROUND OF THE INVENTION

1. Field of the Invention

The invention herein relates to an improved structure tape rule housing, specifically a tape rule housing consisting of pliant rubber material, exterior layer ruler blade housing jackets of a color different from that of the interior layer ruler blade housings which cover the upper edge or the lower edge at both the left and right side of the interior layer ruler blade housings to increase grasping friction and utilization comfort. At the same time, the interior layer ruler blade housing has reliefed labeling and markings, and by design the exterior layer ruler blade housing jackets each have a reticulation aligned with the positions of the labeling and markings. The exterior layer ruler blade housing jackets are fitted over the interior layer ruler blade housings, enabling the visual exposure of the interior layer ruler blade housing labeling and markings through the exterior layer ruler blade housing jackets thereby increasing the practical value of the tape rule housing structure.

2. Description of the Prior Art

In conventional tape rules, referring to FIG. 1, the outer housing of the said tape rule 10 consists of a left half and a right half 11 and 14 that are unitarily injection-molded from a plastic material and then assembled together; in terms of grasping friction, slippage readily occurs during handling and, furthermore, labeling and markings 12 and 13 are incised in the side of the left half 11, and since the labeling and markings 12 and 13 use the same material and also color as the left half 11, visual discernment is unclear. However, to enable better tape rule utilization convenience, the applicant of the invention herein conducted intensive research and development based on many years of professional manufacturing experience that culminated in the successful completion of the improved structure tape rule housing herein which, as substantiated by repeated testing, affords greater practical value.

### SUMMARY OF THE INVENTION

The primary objective of the invention herein is to provide an improved structure tape rule housing, wherein the said tape rule housing consists of pliant rubber material, exterior layer ruler blade housing jackets of a color different from that of the interior layer ruler blade housings which cover the upper edge or lower edge at both the left and right side of the interior layer ruler blade housings to increase grasping friction and utilization comfort. At the same time, the said interior layer ruler blade housing has reliefed labeling, and by design the exterior layer ruler blade housing jackets each have a reticulation aligned with the positions of the labeling; the exterior layer ruler blade housing jackets are fitted over the interior layer ruler blade housings, enabling the visual exposure of the interior layer ruler blade housing labeling and markings through the exterior layer ruler blade housing jackets thereby increasing the practical value of the tape rule housing structure.

To enable the examination committee a further understanding of the structure, original content, advantages, and other features of the present invention the detailed description of the embodiments to follow are accompanied by brief description of the drawings below.

### BRIEF DESCRIPTION OF THE DRAWINGS

FIG. 1 is an isometric drawing of a conventional product.

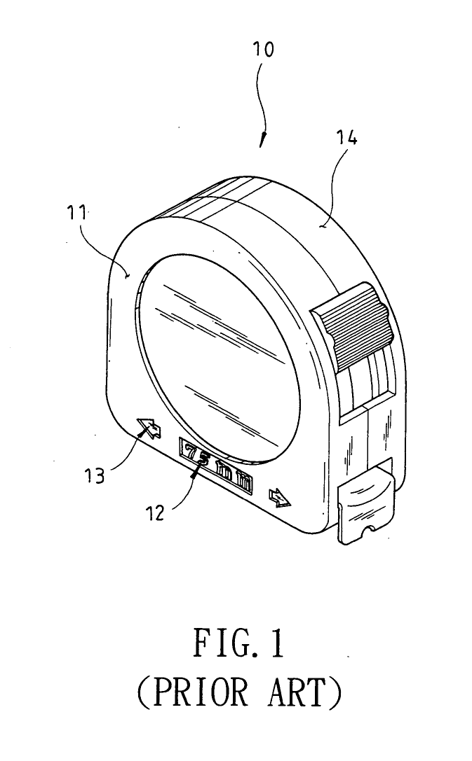

FIG. 2 is an isometric drawing of the invention herein.

FIG. 3 is an isometric drawing of the interior layer ruler blade housings 21 and 24.

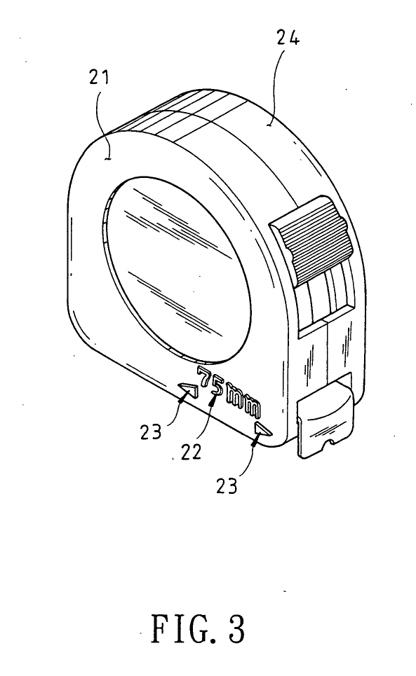

FIG. 4 is an isometric drawing of the exterior layer ruler blade housing 3.

### DETAILED DESCRIPTION OF THE INVENTION

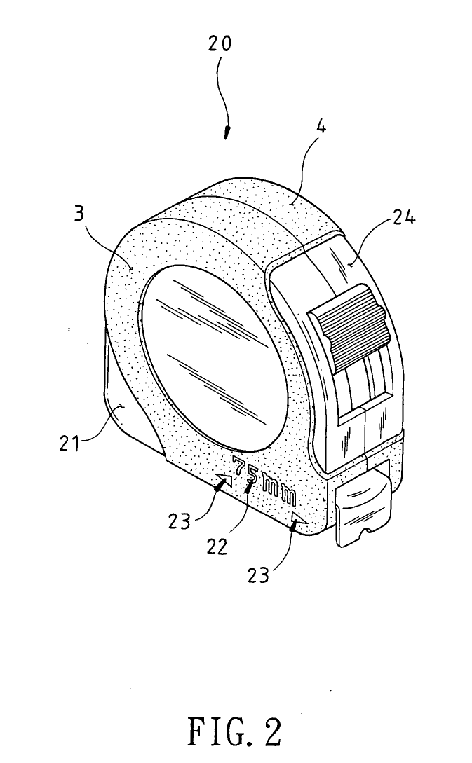

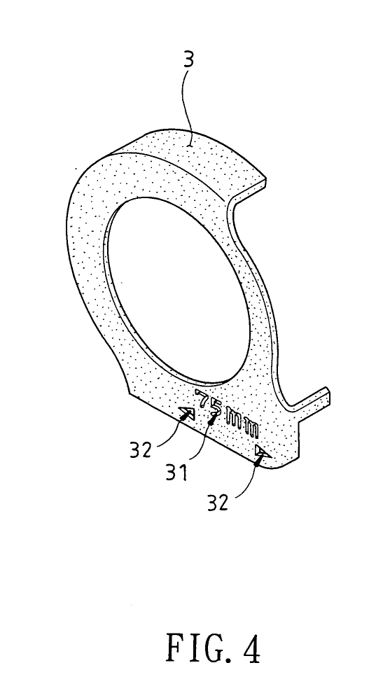

The objective of the invention herein is to provide an improved structure tape rule housing in which, referring to FIG. 2 and FIG. 4, the improved structure tape rule housing of the invention herein, the interior layer ruler blade housings 21 and 24 of the said tape rule are constructed of a single injection-molded plastic material, with labeling 22 and markings 23 reliefed on one side of the interior layer ruler blade housing 21; covering the upper edge or lower edge of the interior layer ruler blade housings 21 and 24, and of a color different from that of the interior layer ruler blade housings 21 and 24, are double injection-molded pliant rubber material, exterior layer ruler blade housing jackets 3 and 4 that each have a reticulation 31 and 32 aligned with the positions of the labeling 22 and markings 23.

The exterior layer ruler blade housing jackets 3 and 4 are fitted over the interior layer ruler blade housings 21 and 24 such that the interior layer ruler blade housing 21 and 24 labeling 22 and markings 23 are visually exposed through the exterior layer ruler blade housing jackets 3 and 4 and, furthermore, grasping friction and utilization comfort are increased, enabling tape rule housings of greater flexible variability and higher practicality.

The said description elaborates a workable embodiment of the invention herein, however, the said embodiment shall not be construed as a limitation of the present invention and, furthermore, all adaptations and modifications based on the technological spirit thereof remain included under the patent claims of the invention herein.

In summation of the foregoing section, since the invention herein is of an original spatial arrangement and, furthermore, is of demonstrable utilitarian functionality and possesses considerable practical value, the present invention is submitted to the examination committee for review and the granting of the commensurate patent rights.

1. (canceled)

2. A tape rule housing apparatus comprising:
an interior layer ruler blade housing portion having a plurality of openings formed through an outer surface thereof, said interior layer ruler blade housing portion including labeling and marking formed in reliefed manner on said outer surface;
an exterior layer ruler blade housing jacket portion partially covering said interior layer ruler blade housing portion formed of a molded pliant rubber material to be visually distinguishable from said interior layer ruler blade housing portion, said exterior layer ruler blade housing jacket portion defining at least first and second access openings, said first access opening being aligned with said labeling and marking of said interior layer ruler blade housing portion for visual exposure of said labeling and marking therethrough, said second access opening being aligned with one of said openings of said interior layer ruler blade housing portion.

3. The tape rule housing apparatus as recited in claim 1 wherein said labeling and marking extend into said first opening.

4. The tape rule housing apparatus as recited in claim 1 wherein said opening of said interior layer ruler blade housing aligned with said second access opening defines a passage for a ruler blade housed by the tape rule housing apparatus.
